(19) United States
(12) Patent Application Publication
(10) Pub. No.: US 2025/0130514 A1
(43) Pub. Date: Apr. 24, 2025

(54) ELECTROSTATIC CHARGE IMAGE DEVELOPING TONER AND IMAGE FORMING METHOD

(71) Applicant: KONICA MINOLTA, INC., Tokyo (JP)

(72) Inventors: Atsushi IIOKA, Kawasaki-shi (JP); Kazuya ISOBE, Tokyo (JP); Yukiko NAKAI, Kawasaki-shi (JP); Shiori TSUDA, Tokyo (JP); Genki WATANABE, Tokyo (JP)

(73) Assignee: KONICA MINOLTA, INC., Tokyo (JP)

(21) Appl. No.: 18/919,597

(22) Filed: Oct. 18, 2024

(30) Foreign Application Priority Data
Oct. 23, 2023 (JP) 2023-181525

(51) Int. Cl. G03G 9/087

(52) U.S. Cl. CPC G03G 9/08755

(57) ABSTRACT

Disclosed is an electrostatic charge image developing toner including a toner base particle containing a binder resin and a colorant. The electrostatic charge image developing toner contains, as the binder resin, a polymer having at least a structural unit represented by a general formula (1), and a concentration of radiocarbon isotope ¹⁴C is 21.5 pMC or more, and in the general formula (1), R₁ represents a hydrogen atom or a methyl group, and R₂ represents an alicyclic hydrocarbon group having 6 to 12 carbon atoms.

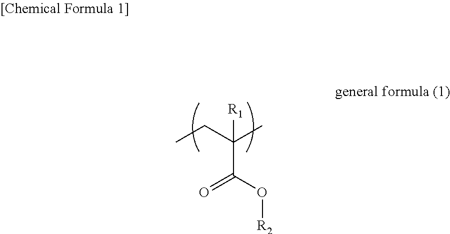

### BACKGROUND OF THE INVENTION

### Technical Field

The present invention relates to an electrostatic charge image developing toner, and in particular, to a toner for electrostatic charge image development capable of achieving both fixing property and heat-resistant storage property while increasing the ratio of a biomass-derived material, and the like.

### Description of Related Art

JP 2023-67691-A discloses a technique of using a biomass-derived resin and a recycle-derived resin as resin fine particles for an environmentally-friendly toner having excellent fixing property and storage stability.

However, when the proportion of the biomass-derived material is increased, fixing property and heat-resistant storage property cannot be sufficiently ensured. Therefore, as an environmentally friendly toner, further improvement in the ratio of biomass-derived materials and further improvement in fixing property and heat-resistant storage property are both required.

### SUMMARY OF THE INVENTION

The present invention has been made in consideration of the above-mentioned problems and situations. The problem to be solved by the present invention is to provide a toner for electrostatic charge image development and an image forming method which are environmentally friendly by increasing the ratio of a biomass-derived material and can achieve both fixing property and heat-resistant storage property.

To achieve the object, the present inventors have studied the causes of the above problems and the like. As a result, the present inventors have found that by using a biomass-derived material and an alicyclic alkyl-based monomer, it is possible to use the biomass-derived material at a higher ratio while maintaining fixing property and heat-resistant storage property.

To achieve at least one of the abovementioned objects, according to an aspect of the present invention, electrostatic charge image developing toner reflecting one aspect of the present invention is an electrostatic charge image developing toner comprising a toner base particle containing a binder resin and a colorant, wherein
the electrostatic charge image developing toner contains, as the binder resin, a polymer having at least a structural unit represented by a general formula (1), and
a concentration of radiocarbon isotope ¹⁴C is 21.5 pMC or more,

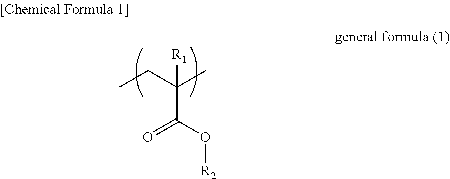

in the general formula (1), R₁ represents a hydrogen atom or a methyl group, and R₂ represents an alicyclic hydrocarbon group having 6 to 12 carbon atoms.

### DETAILED DESCRIPTION

Hereinafter, one or more embodiments of the present invention will be described with reference to the drawings. However, the scope of the invention is not limited to the disclosed embodiments.

The electrostatic charge image developing toner of the present embodiment is an electrostatic charge image developing toner including toner base particles containing a binder resin and a colorant, wherein as the binder resin, there is contained a polymer having at least a structural unit represented by the following General Formula (1), and the concentration of the radiocarbon isotope ¹⁴C is 21.5 pMC or more.

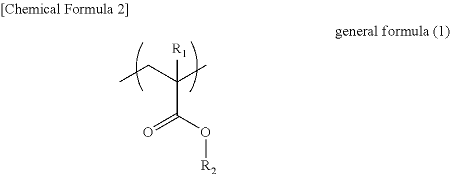

In the general formula (1), R₁ represents a hydrogen atom or a methyl group. R₂ represents an alicyclic hydrocarbon group having 6 to 12 carbon atoms.

This feature is a technical feature common to or corresponding to the following embodiments.

In an embodiment of the present invention, the polymer having the structural unit represented by the general formula (1) preferably has a weight average molecular weight in a range of 5000 to 100000 as measured by gel permeation chromatography. When the average molecular weight is within the range of 5000 to 100000, the toner has excellent heat-resistant storage property and fixing property.

The concentration of the radiocarbon isotope ¹⁴C is preferably 32.3 pMC or more from the viewpoint of making the toner more environmentally friendly.

R₂ in the general formula (1) is preferably an isobornyl group in that heat-resistant storage property of the binder resin is improved.

The R₁ in the general formula (1) is preferably methyl group from the viewpoint that the main chain becomes rigid and the heat-resistant storage property is excellent.

It is preferable that the toner base particles contain the crystalline polyester in the range of 5 to 20% by mass from the viewpoint of improving fixing property and heat-resistant storage property.

The electrostatic charge image developing toner according to the present embodiment is suitably used in an image forming method.

Hereinafter, the present embodiment, constituent elements thereof, and modes and aspects for carrying out the present embodiment will be described. In the present description, when two figures are used to indicate a range of value before and after “to”, these figures are included in the range as a lower limit value and an upper limit value.

### Electrostatic Charge Image Developing Toner of the Present Embodiment

The electrostatic charge image developing toner of the present embodiment is an electrostatic charge image developing toner including toner base particles containing a binder resin and a colorant, wherein as the binder resin there contains a polymer having at least a structural unit represented by the following General Formula (1), and the concentration of a radiocarbon isotope ¹⁴C is 21.5 pMC or more.

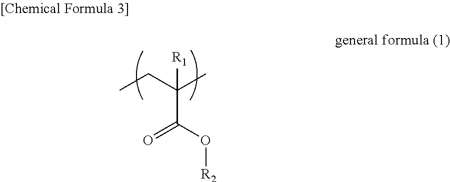

In the general formula (1), R₁represents a hydrogen atom or a methyl group, and R₂ represents an alicyclic hydrocarbon group having 6 to 12 carbon atoms.

### <Concentration of Radiocarbon Isotope ¹⁴C>

The concentration of the radiocarbon isotope ¹⁴C is 21.5 pMC or more, and preferably in the range of 32.3 to 85.6 pMC.

The concentration of the radiocarbon isotope ¹⁴C is a ratio of the radiocarbon isotope ¹⁴C to the total carbon elements in the entire toner. The concentration of radiocarbon isotopes ¹⁴C is known as an indicator of the content of biomass. That is, the concentration of the ¹⁴C indicates how much organic components are derived from the biomass in the toner containing the organic components. The unit of the concentration of ¹⁴C is pMC (percent Modern Carbon).

In addition to ¹²C, which is a stable isotope, ¹⁴C, which is a radiocarbon isotope, is contained in the carbon dioxide gas present in the atmosphere. The concentration of ¹⁴C in the atmosphere is kept approximately constant (107.5 pMC). Plants continue to take in carbon dioxide from the atmosphere while maintaining their life activities, and therefore the concentration of ¹⁴C in the cells is substantially equal to the concentration of ¹⁴C in the atmosphere (107.5 pMC).

On the other hand, when the plant stops its life activity, the concentration of the ¹⁴C in the cell decreases at a constant rate (half-life: 5730 year). Since animals continue to directly or indirectly ingest plants while maintaining their life activities, the concentration of ¹⁴C in the cells of animals shows the same tendency as the concentration of ¹⁴C in the cells of plants. Biomass is utilized in a relatively short period of time after a plant stops life activity. Therefore, the concentration of ¹⁴C in the biomass is substantially equal to the concentration of ¹⁴C in the atmosphere (107.5 pMC).

On the other hand, fossil resources such as petroleum are used after tens of thousands to hundreds of millions of years have elapsed since animals and plants from which they are derived stopped their life activities. Therefore, ¹⁴C is hardly detected from fossil resources. From the foregoing, the concentration of ¹⁴C of a chemical product using only fossil resources such as petroleum as a raw material is almost 0 pMC.

On the other hand, chemical products produced using biomass as a starting material have a higher ¹⁴C concentration in proportion to the amount of biomass used.

Chemical products using a large amount of biomass do not increase the concentration of carbon dioxide in the atmosphere so much in terms of carbon neutral even if they are combusted. Therefore, chemical products that use a large amount of biomass are effective in reducing the load on the environment.

The ratio of the mass of biomass-derived carbon atoms to the total mass of carbon atoms in the toner particles (also referred to as the biomass degree or the bio-based carbon content) is calculated by the following formula. In the following formula, X represents the concentration of the radiocarbon isotopes ¹⁴C in the entire toner.

$$Biomass degree [ \% by mass ] = ( X / 107.5 ) \times 100$$

The concentration of the radiocarbon isotope ¹⁴C can be measured using, for example, an accelerator mass spectrometer (AMS). In particular, the concentration of ¹⁴C can be measured in accordance with ASTM D6866.

Furthermore, in the present embodiment, the concentration of ¹⁴C can also be calculated by the following method.

For example, a case where a radiocarbon isotope is used in a monomer constituting an acrylic resin which is a binder resin of toner base particles will be described as an example.
(I) For each monomer, the A1 value is calculated by the following equation.

$$A 1 = number of moles of monomers constituting acrylic resin \times$$

$$number of carbons of the monomers$$

(In the case of isobornyl acrylate (IBXMA)) of an acrylic resin (1) of an example described later, A1=0.1889) (See Table IV).
(ii) A total value A1 of the calculated values of A2 is calculated.
(In the case of the acrylic resin (1), A2=1.9853. (See Table IV))
(iii) For each monomer, the B1 value is calculated by the following equation.

$$B 1 = number of moles of monomers constituting acrylic resin \times number of biomass - derived carbon atoms of the monomers$$

(In the case of isobornyl acrylate of the acryl resin (1), B1=0.1889. (See Table IV))
(iv) A total value B2 of the calculated values of B1 is calculated.
(In the case of the acryl resin (1), B2=0.7871. (See Table IV))
(v) The biomass degree Y1 in the acrylic resin is calculated from the following formula.

$$Biomass degree in acrylic resin Y 1 = ( B 2 / A 2 ) \times 100$$

(for the acrylic resin (1), Y1=(0.7871/1.9853)×100=39.6% (see Table IV))
(vi) A biomass degree Y2 in the entire toner is calculated using the following equation.

$$Biomass degree in entire toner Y 2 = Y 1 \times Ratio of acrylic resin in entire toner$$

(in the case of the toner 1 using the acryl resin (1), Y2=39.6×74%=29.1% (see Table V))
(vii) The concentration X of the ¹⁴C is calculated by the following formula.

$$concentration X of {}^{14} C = ( biomass degree Y 2 / 100 ) \times 107.5$$

(for the toner 1, X=(29.1/100)×107.5=31.3 (see Table V))

In the toner of the present embodiment, the concentration of the ¹⁴C in the toner particles is 21.5 pMC or more. Therefore, the biomass degree is generally 20.0% by mass or more.

Such a toner having a biomass degree of 20.0% by mass or more is a product using a relatively large amount of biomass as a raw material, and therefore is environmentally friendly.

As means for setting the concentration of the ¹⁴C to 21.5 pMC or more, for example, it is preferable to set the biomass degree of the acrylic resin as the binder resin of the toner base particles to 25 to 40% by mass and to set the ratio of the acrylic resin in the toner base particles to 50 to 80% by mass.

In addition, in the present embodiment, as the biomass-derived material, for example, various monomers used in an acrylic resin which is a binder resin described below preferably have a biomass-derived carbon atom. In particular, isobornyl acrylate, methacrylic acid, N-butylacrylic acrylate, and the like, which will be described later, preferably have a biomass-derived carbon atom.

### Configuration of Electrostatic Charge Image Developing Toner

Hereinafter, the electrostatic charge image developing toner according to the present embodiment is also simply referred to as “toner”.

The toner of the present embodiment includes toner particles each including a toner base particle and an external additive disposed on the surface of the toner base particle.

In the present specification, the term “toner base particles” refers to a base of “toner particles”. The “toner base particles” according to the present embodiment contain at least a binder resin. In addition, the toner base particles may contain other constituent components such as a colorant, a release agent (wax), and a charge control agent, if necessary. The “toner base particles” are referred to as “toner particles” by addition of an external additive. The term “toner” refers to an aggregate of toner particles.

### <Toner Base Particles>

The toner base particles according to the present embodiment contain a binder resin and a colorant.

The toner base particles contain, as the binder resin, a polymer having at least a structural unit represented by the following general formula (1).

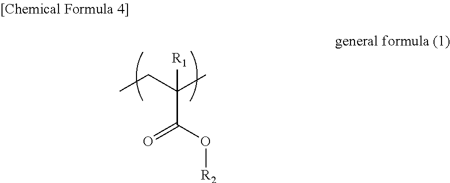

In the general formula (1), R₁ represents a hydrogen atom or a methyl group, and preferably represents a methyl group.

R₂ represents an alicyclic hydrocarbon group having 6 to 12 carbon atoms. R₂ Preferably represents an isobornyl group, a cyclohexyl group, an adamantyl group or the like. R₂ Is particularly preferably an isobornyl group from the viewpoint of improving the heat-resistant storage property of the binder resin.

Examples of the monomer having the structural unit represented by the general formula (1) include isobornyl methacrylate, isobornyl acrylate, cyclohexyl acrylate, cyclohexyl methacrylate, adamantyl acrylate, and adamantyl methacrylate.

It is preferable that the weight average molecular weight of the polymer having the structural unit represented by the general formula (1), as measured by gel permeation chromatography, is within the range of 5000 to 100000, in terms of excellent heat-resistant storage property and fixing property.

The weight average molecular weight of the polymer can be measured by gel permeation chromatography (GPC) in terms of polystyrene.

To be specific, a GPC apparatus HLC-8120GPC (manufactured by Tosoh Corporation) and a column TSKguardcolumn+TSKgelSuperHZ-m3 series (manufactured by Tosoh Corporation) are used. Next, while the column temperature is maintained at 40° C., tetrahydrofuran as a carrier-solvent is allowed to flow at a flow rate of 0. 2 mL/min. Thereafter, the measurement sample is dissolved in tetrahydrofuran so as to have a concentration of 1 mg/ml under dissolution conditions in which the sample is treated for 5 minutes using an ultrasonic disperser at room temperature. Next, the resultant is treated with a membrane filter having a pore size of 0.2 μm to obtain a sample solution. Then, 10 μL of the prepared sample solution is injected into the GPC device. The sample is detected using a refractive index detector (RI detector), and the molecular weight distribution of the sample is calculated using a calibration curve measured using monodisperse polystyrene standard particles.

The binder resin according to the present embodiment may be a polymer having at least the structural unit represented by General Formula (1), and examples thereof include a styrene-acrylic copolymer resin and an acrylic resin. Among these, a styrene-acrylic copolymer resin excellent in heat resistance is preferable.

In addition, the toner base particle according to the present embodiment may contain a styrene resin or a polyester in addition to the polymer having the structural unit represented by Formula (1).

Furthermore, the toner base particle according to the present embodiment may contain a styrene-acrylic copolymer resin or an acrylic resin other than the polymer having the structural unit represented by Formula (1).

The toner base particles may also contain a resin other than polyester. Such a resin is not particularly limited, and a known resin can be used, and one type or a plurality of types may be used.

Hereinafter, a styrene-acrylic copolymer resin will be described as an example of the polymer having the structural unit represented by Formula (1).

### <Styrene-Acrylic Copolymer Resin>

The styrene-acrylic copolymer resin is formed by addition polymerization of at least a styrene monomer and a (meth) acrylic acid ester monomer. The styrene monomer includes, in addition to styrene represented by the structural formula of CH₂═CH—C₆H₅, a styrene derivative having a known side chain or functional group in the styrene structure.

Hereinafter, the styrene-acrylic copolymer resin is also referred to simply as a “styrene-acrylic resin”.

### ((Meth) Acrylic Acid Ester Monomer)

The (meth) acrylate ester monomers include acrylate esters and methacrylate esters represented by CH (Ra)=CHCOORb (wherein Ra is hydrogen or methyl, and Rb is an alkyl radical having 1 to 24 carbon atoms), as well as acrylate ester derivatives and methacrylate ester derivatives having known side chains and functional groups in the structures of these esters.

Examples of the (meth) acrylic acid ester monomer include the following, in addition to the monomer including the structural unit represented by General Formula (1) described above. Acrylic acid ester monomers such as methyl acrylate, ethyl acrylate, isopropyl acrylate, N-butyl acrylate, t-butyl acrylate, isobutyl acrylate, N-octyl acrylate, 2-ethylhexyl acrylate, stearyl acrylate, lauryl acrylate and phenyl acrylate; methacrylic acid ester monomers such as methyl methacrylate, ethyl methacrylate, N-butyl methacrylate, isopropyl methacrylate, isobutyl methacrylate, t-butyl methacrylate, N-octyl methacrylate, 2-ethylhexyl methacrylate, stearyl methacrylate, lauryl methacrylate, phenyl methacrylate, diethylaminoethyl methacrylate and dimethylaminoethyl methacrylate.

Note that in the present specification, the term “(meth) acrylic acid ester monomer” is a generic term for “acrylic acid ester monomer” and “methacrylic acid ester monomer”, and means one or both of them. For example, “methyl (meth) acrylate” means one or both of “methyl acrylate” and “methyl methacrylate”.

The (meth) acrylic acid ester monomer may be one or more kinds thereof, as long as the monomer includes the monomer including the structural unit represented by the general formula (1) described above. For example, any of the following is possible. A copolymer is formed using a styrene monomer and two or more kinds of acrylic acid ester monomers, a copolymer is formed using a styrene monomer and two or more kinds of methacrylic acid ester monomers, and a copolymer is formed using a styrene monomer, an acrylic acid ester monomer and a methacrylic acid ester monomer in combination.

### (Styrene Monomer)

Examples of the styrene monomer include the following. Styrene, o-methylstyrene, m-methylstyrene, p-methylstyrene, α-methylstyrene, p-phenylstyrene, p-ethylstyrene, 2,4-dimethylstyrene, p-tert-butylstyrene, p-n-hexylstyrene, p-n-octylstyrene, p-n-nonylstyrene, p-n-decylstyrene and pn-dodecylstyrene.

### (Preferred Configuration of Styrene-Acrylic Resin)

From the viewpoint of controlling the plasticity of the styrene-acrylic resin, the content of the constituent unit derived from a styrene monomer in the styrene-acrylic resin is preferably within a range of 40 to 90% by mass. In addition, the content is more preferably in a range of 50 to 85% by mass, even more preferably in a range of 60 to 80% by mass, and still more preferably in a range of 65 to 75% by mass.

The content of a constituent unit derived from a (meth) acrylic acid ester monomer in the styrene-acrylic resin is preferably within a range of 10 to 60% by mass. Furthermore, the content is more preferably in a range of 15 to 50% by mass, even more preferably in a range of 20 to 40% by mass, and still more preferably in a range of 15 to 35% by mass.

### (Other Monomers)

The styrene-acrylic resin may further contain a constituent unit derived from a monomer other than the styrene monomer and the (meth) acrylic acid ester monomer.

The other monomer is preferably a compound that forms an ester bond with a hydroxy group (—OH) derived from a polyhydric alcohol or a carboxy group (—COOH) derived from a polyvalent carboxylic acid. That is, the styrene-acrylic resin is preferably a polymer obtained by further polymerizing a compound (amphoteric compound) which is addition-polymerizable with the styrene monomer and the (meth) acrylic acid ester monomer and has a carboxy group or a hydroxy group.

### (Amphoteric Compound)

Examples of the amphoteric compound include the following. Compounds having a carboxy group, such as acrylic acid, methacrylic acid, maleic acid, itaconic acid, cinnamic acid, fumaric acid, maleic acid monoalkyl ester, and itaconic acid monoalkyl ester; and compounds having a hydroxy group, such as 2-hydroxyethyl (meth) acrylate, 2-hydroxypropyl (meth) acrylate, 3-hydroxypropyl (meth) acrylate, 2-hydroxybutyl (meth) acrylate, 3-hydroxybutyl (meth) acrylate, 4-hydroxybutyl (meth) acrylate, and polyethylene glycol mono (meth) acrylate.

(Preferred Content of Constituent Unit Derived from Amphoteric Compound)

The content of the constituent unit derived from the amphoteric compound in the styrene-acrylic resin is preferably in a range of 0.5 to 20% by mass and more preferably in a range of 5 to 10% by mass.

In an embodiment of the present invention, in the styrene-acrylic resin, the total of the ratio of the content of the constituent unit derived from a styrene monomer, the ratio of the content of the constituent unit derived from a (meth) acrylic acid ester monomer, and the ratio of the content of the constituent unit derived from an amphoteric compound is 100% by mass.

### (Synthesis Method of Styrene-Acrylic Resin)

The styrene-acrylic resin can be synthesized by a method of polymerizing monomers using a known oil-soluble or water-soluble polymerization initiator. Examples of the oil-soluble polymerization initiator include azo-based or diazo-based polymerization initiators and peroxide-based polymerization initiators.

### (Azo-Based or Diazo-Based Polymerization Initiator)

Examples of the azo-or diazo-based polymerization initiator include the following. 2,2′-azobis-(2,4-dimethyl valeronitrile), 2,2′-azobisisobutyronitrile, 1, 1′-azobis (cyclohexane-1-carbonitrile), 2,2′-azobis-4-methoxy-2,4-dimethyl valeronitrile and azobisisobutyronitrile.

### (Peroxide-Based Polymerization Initiator)

Examples of the peroxide-based polymerization initiator include the following. Benzoyl peroxide, methyl ethyl ketone peroxide, diisopropylperoxycarbonate, cumenehydroperoxide, t-butylhydroperoxide, di-t-butylperoxide, dicumyl peroxide, 2,4-dichlorobenzoyl peroxide, lauroyl peroxide, 2,2-bis-(4,4-t-butylperoxycyclohexyl) propane and tris-(t-butylperoxy) triazines.

### (Water-Soluble Radical Polymerization Initiator)

When the resin particles of the styrene-acrylic resin are synthesized by an emulsion polymerization method, a water-soluble radical polymerization initiator can be used as a polymerization initiator. Examples of the water-soluble radical polymerization initiator include persulfates such as potassium persulfate and ammonium persulfate, azobisaminodipropane acetate, azobiscyanovaleric acid and salts thereof, and hydrogen peroxide.

### (Preferred Weight Average Molecular Weight of Styrene-Acrylic Resin)

The weight average molecular weight (Mw) of the styrene-acrylic resin is preferably within a range of 5000 to 100000 from the viewpoint that its plasticity is easily controlled. Furthermore, the weight average molecular weight is more preferably within a range of 10,000 to 70000, and still more preferably within a range of 15000 to 60000. Furthermore, the weight average molecular weight is more preferably within a range of 20000 to 40000, and still more preferably within a range of 25000 to 35000.

The weight average molecular weight of the styrene-acrylic resin can be measured in terms of polystyrene by gel permeation chromatography (GPC) in the same manner as in the weight average molecular weight of the polymer described above.

The toner base particles according to the present embodiment preferably contain the styrene-acrylic resin in a range of 65 to 90% by mass.

### <Polyester>

The polyester used in the binder resin may be a crystalline polyester or an amorphous polyester, but is preferably an amorphous polyester from the viewpoint of chargeability.

In the present embodiment, the “crystalline resin” refers to a resin having a melting point, that is, a clear endothermic peak during temperature increase in an endothermic curve obtained by differential scanning calorimetry (DSC). The “clear endothermic peak” refers to a peak having a half value width of 15° C. or less in an endothermic curve when the temperature is increased at a temperature increase rate of 10° C./min. On the other hand, the “amorphous resin” refers to a resin in which, in an endothermic curve obtained by performing differential scanning calorimetry in the same manner as described above, a curve of a base line indicating the occurrence of glass transition is observed, but the above-described clear endothermic peak is not observed.

### (Crystalline Polyester)

The crystalline polyester is a resin exhibiting crystallinity among known polyesters obtained by a polycondensation reaction of a carboxylic acid having a valency of two or more (polyvalent carboxylic acid) and a derivative thereof with an alcohol having a valency of two or more (polyhydric alcohol) and a derivative thereof.

The polyvalent carboxylic acid component for forming the crystalline polyester is a compound containing two or more carboxy groups in one molecule. Specifically, for example, the following can be mentioned. Examples thereof include saturated aliphatic dicarboxylic acids such as succinic acid, sebacic acid, and dodecanedioic acid; alicyclic dicarboxylic acids such as cyclohexanedicarboxylic acid; aromatic dicarboxylic acids such as phthalic acid, isophthalic acid, and terephthalic acid; trivalent or higher-valent polyvalent carboxylic acids such as trimellitic acid and pyromellitic acid; and anhydrides or alkyl esters having 1 to 3 carbon atoms of these carboxylic acid compounds. As the polyvalent carboxylic acid component for forming the crystalline polyester, a saturated aliphatic dicarboxylic acid is preferably used. These may be used alone or in combination of two or more kinds thereof.

The polyhydric alcohol component for forming the crystalline polyester is a compound containing two or more hydroxy groups in one molecule. Specifically, for example, the following can be mentioned. Aliphatic diols such as ethylene glycol, 1,2-propanediol, 1,3-propanediol, 1,4-butanediol, 1,5-pentanediol, 1,6-hexanediol, 1,7-heptanediol, 1,8-octanediol, neopentyl glycol, and 1,4-butenediol; and polyhydric alcohols having three or more hydroxyl groups such as glycerin, pentaerythrytol, trimethylolpropane, and sorbitol. As the polyhydric alcohol component for forming the crystalline polyester, an aliphatic diol is preferably used. These may be used alone or in combination of two or more kinds thereof.

The method for producing the crystalline polyester is not particularly limited, and the crystalline polyester can be produced using a general polyester polymerization method in which the above-described polyvalent carboxylic acid and polyhydric alcohol are reacted in the presence of a catalyst. As the production method, for example, direct polycondensation or ester exchange method is preferably used depending on the kind of the monomer.

Furthermore, a straight-chain aliphatic hydroxycarboxylic acid can be used in combination with the polyvalent carboxylic acid and/or the polyhydric alcohol.

Examples of linear aliphatic hydroxycarboxylic acid for forming the crystalline polyester include the following. 5-hydroxypentanoic acid, 6-hydroxyhexanoic acid, 7-hydroxypentanoic acid, 8-hydroxyoctanoic acid, 9-hydroxynonanoic acid, 10-hydroxydecanoic acid, 12-hydroxydodecanoic acid, 14-hydroxytetradecanoic acid, 16-hydroxyhexadecanoic acid, 18-hydroxyoctadecanoic acid; and lactone compounds obtained by cyclization of these hydroxycarboxylic acids, or alkyl esters with alcohols having 1 to 3 carbon atoms. These may be used alone or in combination of two or more kinds thereof.

In addition, use of a polyvalent carboxylic acid and a polyhydric alcohol component in the formation of the crystalline polyester is preferable because the reaction can be readily controlled and a resin having a target molecular weight can be obtained.

Examples of the catalyst that can be used in the production of the crystalline polyester include titanium catalysts such as titanium tetraethoxide, titanium tetrapropoxide, titanium tetraisopropoxide, and titanium tetrabutoxide. Furthermore, examples of the catalyst include tin catalysts such as dibutyltin dichloride, dibutyltin oxide, and diphenyltin oxide.

The polyvalent carboxylic acid component and the polyhydric alcohol component are used in such proportions that the equivalent ratio [OH]/[COOH] of hydroxy groups [OH] in the polyhydric alcohol component to carboxy groups [COOH] in the polyvalent carboxylic acid component is preferably 1.5/1 to 1/1.5. Furthermore, the equivalent ratio [OH]/[COOH] is preferably within a range of 1.2/1 to 1/1.2.

The acid number of the crystallizable polyester is preferably in a range of 5 to 30 mgKOH/g, more preferably 10 to 25 mgKOH/g, and still more preferably 15 to 25 mgKOH/g. The acid number is the weight in mg of KOH required to neutralize the acids in a sample of 1 g. The acid values of the resins are measured by the following procedure according to JIS K0070-1992.

### (Preparation of Reagent)

Phenolphthalein 1.0 g is dissolved in ethyl alcohol (95 vol %) 90 mL, and ion-exchanged H2O is added to make 100 mL. A JIS special grade potassium hydroxide 7 g is dissolved in an ion-exchanged 5 mL, and ethanol (95 vol %) is added to make 1 L. The mixture is placed in an alkali-resistant container so as not to be in contact with carbon dioxide gas, allowed to stand for 3 days, and then filtered to prepare a potassium hydroxide solution. Orientation is as described in JIS K0070-1992.

### (Main Test)

The ground sample 2.0 g is precisely weighed in a 200 mL Erlenmeyer flask, and a mixed solution 100 mL of toluene/ethanol (toluene: ethanol is 2:1 in a volumetric ratio) is added and dissolved over 5 hours. Next, several drops of a phenolphthalein solution prepared as an indicator are added, and titration is performed using the prepared potassium hydroxide solution. Note that the end point of the titration is the time when the pale red color of the indicator lasts for about 30 seconds.

### (Blank Test)

The same operation as in this test is performed except that the sample is not used (that is, only a mixed solution of toluene/ethanol (toluene: ethanol is 2:1 in a volume ratio) is used).

The titration results of this test and the blank test are substituted into the following formula (a) to calculate the acid value.

$$A = [ ( C - B ) \times f \times 5.6 ] / S \qquad Formula ( a )$$

A: acid value (mgKOH/g)
B: an addition amount (mL) of the potassium hydroxide solution at the time of the blank test
C: the addition amount (mL) of the potassium hydroxide solution in the main test
f: Factor of potassium hydroxide-ethanol solutions of f:0.1 mol/L
S: the mass of sample (g)

The weight average molecular weight (Mw) of the crystalline polyester is preferably 3000 to 100000 from the viewpoint of reliably achieving both sufficient low-temperature fixing property and excellent long-term heat-resistant storage property. Furthermore, the weight average molecular weight is more preferably 4000 to 50000, and particularly preferably 5000 to 20000. Regarding the use ratio of the diol component and the dicarboxylic acid component, the ratio [OH]/[COOH] of the equivalent weight of hydroxy groups [OH] in the diol component to the equivalent weight of carboxy groups [COOH] in the dicarboxylic acid component is preferably 1.5/1 to 1/1.5, more preferably 1.2/1 to 1/1.2.

The weight average molecular weight of the crystalline polyester can be measured by gel permeation chromatography (GPC) in terms of polystyrene in the same manner as in the weight average molecular weight of the polymer described above.

The toner base particles according to the present embodiment preferably contain the crystalline polyester in a range of 5 to 20% by mass from the viewpoints of improving fixing property and heat-resistant storage property. If the content of the crystalline polyester is 5% by mass or more, the fixing property becomes satisfactory. When the content of the crystalline polyester is 20% by mass or less, the crystalline polyester is not exposed on the surface of the toner, and heat-resistant storage property is improved.

### (Amorphous Polyester)

The amorphous polyester is obtained by a polycondensation reaction between a carboxylic acid having a valency of two or more (polyvalent carboxylic acid) and an alcohol having a valency of two or more (polyhydric alcohol).

Specific amorphous polyester is not particularly limited, and conventionally known amorphous polyester in the present technical field can be used.

A specific method for producing the amorphous polyester is not particularly limited, and the resin can be produced by polycondensation (esterification) of a polyvalent carboxylic acid and a polyhydric alcohol using a known esterification catalyst.

The weight average molecular weight (Mw) of the amorphous polyester is not particularly limited, but is, for example, preferably in the range of 5000 to 100000, more preferably in the range of 5000 to 50000. When the weight average molecular weight (Mw) is 5000 or more, the heat-resistant storage property of the toner can be improved, and when the weight average molecular weight (Mw) is 100000 or less, the low-temperature fixing property can be further improved.

Examples of the polyvalent carboxylic acid and the polyhydric alcohol used in the preparation of the amorphous polyester include, but are not particularly limited to, the following.

### <<Polyvalent Carboxylic Acid>>

Examples thereof include aromatic carboxylic acids such as terephthalic acid, isophthalic acid, phthalic anhydride, trimellitic anhydride, pyromellitic acid and naphthalenedicarboxylic acid; aliphatic carboxylic acids such as maleic anhydride, fumaric acid, succinic acid, alkenyl succinic anhydride and adipic acid; and alicyclic carboxylic acids such as cyclohexanedicarboxylic acid.

These polyvalent carboxylic acids may be used alone or in combination of two or more kinds thereof.

Among these polyvalent carboxylic acids, an aromatic carboxylic acid is preferably used. In addition, in order to form a cross-linked structure or a branched structure in order to secure more excellent fixing property, a carboxylic acid (trimellitic acid, an acid anhydride thereof, or the like) having 3 or more valences is preferably used in combination with the dicarboxylic acid.

Examples of the carboxylic acid having 3 or more valences include the following. 1,2,3-benzenetricarboxylic acid, 1,2,4-benzenetricarboxylic acid, 1,3,5-benzenetricarboxylic acid, 11,2,4-naphthalenetricarboxylic acid and the like, and anhydrides thereof and lower alkyl esters thereof. These may be used alone or in combination of two or more kinds thereof.

### <<Polyhydric Alcohol>>

Examples of the polyhydric alcohol include aliphatic diols such as ethylene glycol, diethylene glycol, triethylene glycol, propylene glycol, butanediol, hexanediol, neopentyl glycol, and glycerin.

Examples of the polyhydric alcohol include alicyclic diols such as cyclohexanediol, cyclohexanedimethanol, and hydrogenated bisphenol A.

Examples of the polyhydric alcohol include aromatic diols such as an ethylene oxide adduct of bisphenol A and a propylene oxide adduct of bisphenol A. These polyhydric alcohols may be used alone or in combination of two or more kinds thereof.

Of these polyhydric alcohols, aromatic diols and alicyclic diols are preferable, and of these, aromatic diols are more preferable. In addition, in order to secure more favorable fixing property, a polyhydric alcohol having 3 or more valences (glycerin, trimethylolpropane, or pentaerythritol) may be used in combination with the diol in order to form a crosslinked structure or a branched structure.

Note that the acid value of the polyester may be adjusted by further adding a monocarboxylic acid and/or a monoalcohol to the polyester obtained by the polycondensation of the polyvalent carboxylic acid and the polyhydric alcohol to esterify the hydroxy groups and/or the carboxy groups at the polymerization terminals.

Examples of the monocarboxylic acid include acetic acid, acetic anhydride, benzoic acid, trichloroacetic acid, trifluoroacetic acid, and propionic anhydride. Examples of the monoalcohol include methanol, ethanol, propanol, octanol, 2-ethylhexanol, trifluoroethanol, trichloroethanol, hexafluoroisopropanol, phenol, and the like.

As the amorphous polyester used in the present embodiment, a hybrid amorphous polyester in which a vinyl-based polymerization segment formed of a styrene-acrylic polymer or the like and a polyester-based polymerization segment formed of an amorphous polyester are bonded to each other through a bireactive monomer may also be used.

The content ratio of the vinyl-based polymerization segment is preferably in a range of 5 to 30 mass %, and more preferably in a range of 10 to 20% by mass with respect to the total mass of the hybrid amorphous polyester.

When the hybrid amorphous polyester contains the vinyl-based polymerized segment in an amount of 5 to 30% by mass, the balance between charge retention and charge leakage can be controlled.

### <Release Agent>

The toner base particles according to the present embodiment contain a release agent. The release agent is a component that exudes from the toner particles at the time of fixing and enhances the fixing releasability and the like of the toner.

As the release agent, various known waxes can be used. Examples of the wax include the following. Polyolefin waxes such as polyethylene wax and polypropylene wax, branched-chain hydrocarbon waxes such as microcrystalline wax, long-chain hydrocarbon waxes such as paraffin wax and Sasol wax, dialkyl ketone waxes such as distearyl ketone, carnauba wax, montan wax, ester waxes such as behenic acid behenate, trimethylolpropane tribehenate, pentaerythritol tetrabehenate, pentaerythritol diacetate dibehenate, glycerin tribehenate, 1,18-octadecanediol distearate, tristearyl trimellitate and distearyl maleate, amide waxes such as ethylenediamine behenylamide and trimellitic acid tristearylamide, and the like. These release agents may be used alone or in combination of two or more thereof.

The content of the release agent is preferably in a range of 0.1 to 20% by mass and more preferably in a range of 1 to 10% by mass relative to the toner base particles. When the content of the release agent is within the above range, the release agent can be prevented from being exposed on the surface of the toner without being too much. As a result, aggregation of the toner base particles due to the exposed release agent can be prevented, and a reduction in heat-resistant storage property can also be prevented.

The melting point of the release agent is preferably in a range of 50 to 95° C. from the viewpoints of the low-temperature fixing property and the releasability of the toner.

### <Colorant>

The toner base particle according to the present embodiment may contain a colorant.

As the colorant, a known inorganic or organic colorant can be used. As the coloring agent, various organic and inorganic pigments and dyes can be used in addition to carbon black and magnetic powder. In particular, a chromatic pigment is preferably used. As the inorganic pigment, a phthalocyanine-based pigment is preferably used.

The amount of the colorant to be added is preferably in the range of 1 to 10% by mass relative to the toner base particles. When the addition amount is 10% by mass or less, the colorant is not exposed on the surface of the toner

Aggregation of the toner particles due to the exposed colorant is less likely to occur, and the effect of ¹⁴C is also more likely to be exhibited.

### <Charge Control Agent>

The toner base particles according to the present embodiment may contain a charge control agent.

Examples of the charge control agent include known compounds such as nigrosine dyes, metal salts of naphthenic acid or higher fatty acids, alkoxylated amines, quaternary ammonium salts, azo metal complexes, and metal salts of salicylic acid. A toner having excellent chargeability can be obtained by the charge control agent.

The content of the charge control agent is usually preferably within a range of 0.1 to 5.0% by mass relative to the toner base particles.

### <External Additive>

The toner base particles according to the present embodiment may have their surface treated with an external additive. The treatment with an external additive can improve fluidity, chargeability, cleanability, and the like.

Examples of the external additive include inorganic oxide fine particles such as silica fine particles, alumina fine particles, and titanium oxide fine particles. Examples of the external additive include inorganic stearate compound fine particles such as aluminum stearate fine particles and zinc stearate fine particles, and inorganic titanate compound fine particles such as strontium titanate fine particles and zinc titanate fine particles. These may be used alone or in combination of two or more.

These inorganic particles are preferably subjected to a gloss treatment from the viewpoint of improving heat-resistant storage property and environmental stability. The gloss treatment is preferably performed with a silane coupling agent, a titanium coupling agent, a higher fatty acid, silicone oil, or the like.

The amount of the external additive to be added is preferably in a range of 0.05 to 5 parts by mass, and more preferably in a range of 0.1 to 3 parts by mass, relative to 100 parts by mass of the toner base particles.

Note that in a case where a plurality of external additives are used, the total addition amount thereof is preferably within the above range.

### <Particle Diameter of Toner Particle>

The average particle diameter of the toner particles according to the present embodiment is, for example, preferably 3 to 10 μm, and more preferably 5 to 8 μm in terms of volume-based median diameter. The average particle diameter can be controlled by the concentration of the aggregating agent and the addition amount of the organic solvent used in the production, the fusion time, the composition of the binder resin, and the like.

When the volume-based median size is within the above range, a very fine dot image at a 1200 dpi level can be faithfully reproduced.

The volume-based median size of the toner particles is measured and calculated by using a measuring apparatus in which a computer system equipped with data-processing software “Software V3.51” is connected to “Multisizer 3” (manufactured by Beckman Coulter, Inc).

Specifically first, 0.02 g of a measurement sample (toner) is added to and mixed with 20 mL of a surface-active agent (for example, a surface-active agent prepared by diluting a neutral detergent containing surface-active agent components with pure water by a factor of 10 for the purpose of dispersing toner particles). Thereafter, ultrasonic dispersion is performed for 1 minute to prepare a toner dispersion liquid. This toner dispersion liquid is poured into a beaker containing “ISOTONII” (manufactured by Beckman Coulter, Inc) in a sample stand with a pipette until the display concentration of the measuring device becomes 8%. Here, by setting the concentration in the above range, a reproducible measurement value can be obtained.

Then, in the measurement device, the measurement particle count number is set to 25000, the aperture diameter is set to 100 μm, and the frequency value is calculated by dividing the range of 2 to 60 μm which is the measurement range into 256. The particle diameter of 50% from the largest volume integrated fraction is defined as the volume-based median diameter.

### <Average Circularity of Toner Particles>

The average circularity of the toner particles according to the present embodiment is preferably in a range of 0.930 to 1.000, and more preferably in a range of 0.950 to 0.995, from the viewpoint of stability of charging characteristics and low-temperature fixing property.

When the average circularity is within the above range, individual toner particles are less likely to be crushed, contamination of a triboelectric charge-providing member is suppressed, and the chargeability of the toner is stabilized. In addition, the image quality of an image to be formed is high.

The average circularity of the toner particles is a value measured using “FPIA 3000” (manufactured by Sysmex Corporation).

Specifically, the measurement sample (toner) is wetted with an aqueous surfactant-containing solution and subjected to ultrasonic dispersion treatment for 1 minute for dispersion. Thereafter, photographing is performed by “FPIA-3000” (manufactured by Sysmex Corporation) in a measurement condition HPF (high magnification imaging) mode at an appropriate density of 3-,-000 to 10-,-000 HPF detection counts. The circularity is a value calculated by calculating the circularity of each toner particle according to the following formula (y), adding the circularities of the respective toner particles, and dividing the sum by the total number of toner particles. When the number of HPF detections is within the above range, reproducibility is obtained.

$$Circularity = \qquad Expression ( y )$$

$$( Perimeter of circle having the same projected area as particle image ) /$$

$$( Perimeter of particle projection image )$$

### Method for Producing Toner

As a method for producing the electrostatic charge image developing toner according to the present embodiment, known methods such as a kneading pulverization method, a suspension polymerization method, an emulsion aggregation method, a dissolution suspension method, a polyester elongation method, and a dispersion polymerization method may be used. Among these, it is preferable to adopt the emulsion aggregation method. According to the emulsion aggregation method, toner base particles having a sharp particle size distribution and highly controlled particle diameter and toner circularity can be obtained.

The emulsion aggregation method is a method described below. First, a dispersion liquid of fine particles of a binder resin (hereinafter, also referred to as “binder resin fine particles”) dispersed by a surfactant or a dispersion stabilizer is prepared. Next, the dispersion of the binder resin fine particles is mixed with dispersions of various kinds of fine particles to be contained in toner base particles, for example, a dispersion liquid of fine particles of a colorant and dispersion liquids of fine particles of various kinds of components as optional components. Next, an aggregating agent is added to cause aggregation until the toner base particles have a desired particle diameter, and thereafter or simultaneously with the aggregation, fusion between the binder resin fine particles is performed to control the shape. Thus, the toner base particles are formed.

In the method for producing the toner according to the present embodiment, an example of a method for producing toner base particles containing a colorant by an emulsion aggregation method will be described below. A method for producing toner base particles by an emulsion aggregation method includes the following steps (1) to (5), and an external additive is externally added to the toner base particles by the step (6).
(1) Preparing a dispersion liquid in which colorant fine particles are dispersed in an aqueous medium;
(2) A step of preparing a dispersion liquid in which binder resin fine particles containing an internal additive as necessary are dispersed in an aqueous medium;
(3) Mixing a dispersion liquid of colorant fine particles and a dispersion liquid of binder resin fine particles to aggregate, associate, and fuse the colorant fine particles and the binder resin fine particles, thereby forming toner base particles
(4) Filtering out the toner base particles from the dispersion (aqueous medium) of the toner base particles to remove the surfactant and the like
(5) Drying the toner base particles
(6) Adding an external additive to the toner base particles

The dispersion liquid prepared in the production methods (1) and (2) may contain a surfactant or a dispersion stabilizer, if necessary. The dispersion liquid can be prepared by utilizing mechanical energy.

Examples of a disperser for performing dispersion include a low-speed shearing disperser, a high-speed shearing disperser, a friction disperser, a high-pressure jet disperser, an ultrasonic disperser such as an ultrasonic homogenizer, and a high-pressure impact disperser ultimizer.

In the present embodiment, a dispersion liquid containing a compound having a structural unit represented by the general formula (1) is used as the dispersion liquid of the binder resin fine particles.

In addition, in the present embodiment, it is preferable to further use a dispersion liquid of a crystalline polyester in addition to the dispersion liquid of the compound having the structural unit represented by general Formula (1).

The particle diameter of the binder resin particles used in the toner base particles, whether amorphous polymer particles or crystalline polymer particles, is preferably within a range of about 50 to 300 nm in volume-based median size.

Note that the volume-based median diameter of the binder resin particles can be measured with an electrophoretic light scattering photometer, for example, “ELS-800 (manufactured by Otsuka Electronics Co., Ltd)”.

In (3) process of the production method, the fine particles are slowly aggregated while keeping the balance between the repulsive force of the fine particle surface by pH adjustment and the cohesive force by the addition of the aggregating agent comprising the electrolyte. Next, aggregation is performed while controlling the average particle diameter and the particle size distribution, and at the same time, shape control is performed by performing fusion between the fine particles by heating and stirring, thereby forming toner base particles.

The aggregating agent used in the present embodiment is not particularly limited, but one selected from metal salts is suitably used. Examples of the aggregating agent include salts of trivalent metals such as sodium; potassium; a salt of a monovalent metal, such as a salt of an alkali metal, such as lithium; e. g. calcium; magnesium; manganese; salt of a divalent metal such as copper; iron and aluminum. Specific examples of the salt include sodium chloride, potassium chloride, lithium chloride, calcium chloride, magnesium chloride, zinc chloride, copper sulfate, magnesium sulfate, and manganese sulfate.

Among these, salts of divalent metals are particularly preferable. When a salt of a divalent metal is used, aggregation can be advanced with a smaller amount. These may be used alone or in combination of two or more thereof.

In (4), the toner base particles are subjected to solid-liquid separation from the dispersion liquid of the toner base particles with the use of a solvent such as water. Washing is performed to remove adhering substances such as the surfactant from the cake-like aggregate containing the filtered toner base particles.

Specific examples of the solid-liquid separation and washing method include, but are not particularly limited to, a centrifugation method, a vacuum filtration method using an aspirator, a nutsche or the like, and a filtration method using a filter press or the like. At this time, pH adjustment, pulverization, or the like may be appropriately performed. Such operations may be repeated.

(5) Examples of the dryer used in the drying step of the first aspect include an oven, a spray dryer, a vacuum freeze dryer, a reduced pressure dryer, a stationary shelf dryer, a movable shelf dryer, a fluidized bed dryer, a rotary dryer, and a stirring dryer.

Note that the water content in the dried toner base particles as measured by Karl-Fischer coulometric titration method is preferably 5% by mass or less, more preferably 2% by mass or less.

The toner base particle according to the present embodiment includes the toner base particle as a core particle

The toner base particles may have a multilayer structure such as a core-shell structure including a core and a shell layer covering a surface of the core.

The shell layer may not cover the entire surface of the core mother particle, or the core particle may be partially exposed.

The cross section of the core-shell structure can be observed with, for example, a known observation means such as a transmission electron microscope (TEM) or a scanning probe microscope (SPM).

In the case of the core-shell structure, properties such as a glass transition point, a melting point, and hardness can be made different between the core particle and the shell layer, and thus the toner base particle can be designed according to the purpose. For example, a shell layer can be formed by aggregating and fusing a resin having a relatively high glass transition point (Tg) on the surface of a core particle containing a binder resin and fine metal particles and having a relatively low glass transition point (Tg). The shell layers preferably contain an amorphous resin.

The toner base particles having a core-shell structure can be obtained by, for example, the emulsion aggregation method.

Specifically, the toner base particles having a core-shell structure are first prepared by aggregating, associating, and fusing binder resin particles for core particles and metal fine particles. Next, the binder resin particles for the shell layer are added to the dispersion liquid of the core particles, and the binder resin particles for the shell layer are aggregated and fused on the surface of the core particles to form the shell layer covering the surface of the core particles. The optionally used internal additive is preferably contained in the core particle.

In addition, the core particle may be prepared so as to have a multilayer structure of two or more layers formed of binder resins having different compositions. For example, binder resin particles having a three layer structure can be produced by a polymerization reaction for synthesizing the binder resin involving three separate stages: first stage polymerization (formation of the inner layer), second stage polymerization (formation of the intermediate layer), and third stage polymerization (formation of the outer layer).

Here, in each of the polymerization reactions of the first stage polymerization to the third stage polymerization, by changing the composition of the polymerizable monomers, binder resin particles having a three layer structure with different compositions can be produced. Alternatively, for example, synthesis reaction of the binder resin in the presence of an appropriate internal additive such as a release agent in any of the first to third stage polymerizations can form binder resin particles having a three layer structure containing an appropriate internal additive.

In the step (6), an external additive is caused to adhere to the surfaces of the toner base particles obtained in the steps (1) to (5), thereby obtaining the toner according to the present embodiment. As the step (6), specifically, the following method is used.

For the external addition and mixing of the external additive with the toner base particles, a mechanical mixing device can be used.

As the mechanical mixing device, a Henschel mixer, a Nauta mixer, a Turbula mixer or the like can be used. Among these, it is preferable to use a mixing apparatus capable of applying a shearing force to the particles to be treated, such as a Henschel mixer, to perform a mixing treatment such as increasing the mixing time or increasing the rotation peripheral speed of the stirring blade.

In addition, in a case of using a plurality of types of external additives, all of the external additives may be mixed with the toner base particles at once, or the external additives may be mixed a plurality of times in a divided manner according to the external additives.

In addition, in the mixing method of the external additive, for example, the mechanical mixing device is used, and the mixing intensity, that is, the circumferential speed of the stirring blade, the mixing time, the mixing temperature, or the like is controlled, and thus it is possible to control the crushing degree or the adhesion strength of the external additive.

Although some embodiments of the present invention have been specifically described above, embodiments of the present invention are not limited to the above-described examples, and various modifications can be added.

### Developer

The electrostatic charge image developing toner of the present invention can be used as a magnetic or non-magnetic mono-component developer, but may be mixed with a carrier and used as a two component developer.

When the toner is used as a two component developer, magnetic particles made of a conventionally known material such as a metal such as iron, ferrite, or magnetic, or an alloy of such a metal and a metal such as aluminum or lead can be used as the carrier. In particular, ferrite particles are preferable as the carrier.

Furthermore, as the carrier, a coated carrier in which the surfaces of magnetic particles are coated with a coating agent such as a resin, or a dispersion-type carrier in which a magnetic fine powder is dispersed in a binder resin may be used.

The volume-based median diameter (d50) of the carrier is preferably within a range of 20 to 100 μm, and more preferably within a range of 25 to 80 μm.

The volume-based median diameter (d50) of the carrier can be measured with, for example, a laser diffraction particle size distribution analyzer HELOS (manufactured by SYMPATEC GmbH) equipped with a wet disperser.

### Image Forming Method

The image forming method of the present embodiment is characterized by using the above-described electrostatic charge image developing toner of the present embodiment.

In the image forming method according to the present embodiment, for example, an electrostatic charge image formed on a photoreceptor is developed to obtain a toner image, and the toner image is transferred onto an image support. Thereafter, the toner image transferred onto the image support is fixed to the image support by a fixing treatment of a heat and pressure fixing system to obtain a printed matter on which a visible image is formed.

The toner according to the present embodiment can be used in a monochrome image forming method or a full color image forming method.

The present invention is applicable to any full-color image forming method, such as a four cycle image forming method including four types of color developing devices for yellow, magenta, cyan, and black, respectively, and one photoreceptor, or a tandem image forming method including image forming units for the respective colors, each image forming unit including a color developing device and a photoreceptor for each color.

### EXAMPLES

Hereinafter, the present embodiment will be specifically described with reference to Examples, but the present invention is not limited thereto. Note that in the following Examples, operations were performed at room temperature (25° C.) unless otherwise specified. Further, unless otherwise specified, “%” and “part(s)” mean “% by mass” and “part(s) by mass”, respectively.

Hereinafter, for the biomass-derived material (biomass-derived monomer), the numerical value of the charged amount is underlined in Table I below. The monomer other than the biomass-derived monomer may be a commercially available product or a petroleum-derived monomer.

### <Preparation of Acrylic Binder Resin Particle Dispersion Liquid (1)>

A reaction vessel 5 L equipped with a stirrer, a temperature sensor, a cooling tube, and a nitrogen introduction device was prepared. The reaction vessel was charged with an aqueous surfactant solution prepared by dissolving 0.6 parts by mass of an anionic surfactant composed of sodium dodecyl sulfate (C₁₀H₂₁ (OCH₂CH₂)₂SO₃Na) in 2370 parts by mass of ion-exchanged water. Furthermore, a polymerization initiator solution in which 7 parts by mass of potassium persulfate was dissolved in 140 parts by mass of ion-exchanged water was added, and the liquid temperature was raised to 75° C.

As isobornyl methacrylate (IBXMA), N-butyl acrylic acrylate, and methacrylic acid shown below, biomass-derived materials were used.
Styrene (St) 225 parts by mass
isobornyl methacrylate (IBXMA) 41 parts by mass
n-butyl acrylic acrylate (nBA) 122 parts by mass
methacrylic acid (MAA) 43 parts by mass
n-octyl mercaptan (NOM) 4.5 parts by mass

The polymerizable monomer mixed solution was added dropwise over 1 hour. After the dropwise addition, the mixture was heated and stirred at 85° C. for 2 hours to perform polymerization, thereby preparing an acrylic binder resin particle dispersion liquid (1).

### <Preparation of Acrylic Binder Resin Particle Dispersion Liquids (2) to (7)

Acrylic binder resin particle dispersion liquids (2) to (7) were produced by changing the charge amount of the acrylic binder resin particle dispersion liquid (1) as indicated in Table I below. Note that the following Table II shows the monomer ratio of each acrylic binder resin particle dispersion liquid.

Each term in the following Table I and Table II is as follows.
IBXMA: isobornyl methacrylate
CHA: cyclohexyl acrylate
CHMA: cyclohexyl methacrylate
IBXA: isobornyl acrylate
nOA: normal-octyl acrylate
nOMA: normal-octyl methacrylate

Furthermore, the “acrylic resins (1) to (7)” in Tables I and II represent the “acrylic binder resin particle dispersion liquids (1) to (7)”, respectively.

### Table 1

TABLE I

| BINDER RESIN PARTICLE | CHARGE AMOUNT [PARTS BY MASS] | | | | | | | | | |
|---|---|---|---|---|---|---|---|---|---|---|
| DISPERSION LIQUID | St | nBA | MAA | IBXMA | CHA | CHMA | IBXA | nOA | nOMA | NOM |
| ACRYLIC RESIN (1) | 225 | 122 | 43 | 41 | 0 | 0 | 0 | 0 | 0 | 4.5 |
| ACRYLIC RESIN (2) | 225 | 122 | 43 | 0 | 41 | 0 | 0 | 0 | 0 | 4.5 |
| ACRYLIC RESIN (3) | 225 | 122 | 43 | 0 | 0 | 41 | 0 | 0 | 0 | 4.5 |
| ACRYLIC RESIN (4) | 225 | 122 | 43 | 0 | 0 | 0 | 41 | 0 | 0 | 4.5 |
| ACRYLIC RESIN (5) | 225 | 122 | 43 | 41 | 0 | 0 | 0 | 0 | 0 | 1.5 |
| ACRYLIC RESIN (6) | 235 | 122 | 43 | 0 | 0 | 0 | 0 | 41 | 0 | 4.5 |
| ACRYLIC RESIN (7) | 235 | 122 | 43 | 0 | 0 | 0 | 0 | 0 | 41 | 4.5 |

### Table 2

TABLE II

| BINDER RESIN PARTICLE | MONOMER RATIO [% BY MASS] | | | | | | | | |
|---|---|---|---|---|---|---|---|---|---|
| DISPERSION LIQUID | St | nBA | MAA | IBXMA | CHA | CHMA | IBXA | nOA | nOMA |
| ACRYLIC RESIN (1) | 52 | 28 | 10 | 10 | 0 | 0 | 0 | 0 | 0 |
| ACRYLIC RESIN (2) | 52 | 28 | 10 | 0 | 10 | 0 | 0 | 0 | 0 |
| ACRYLIC RESIN (3) | 52 | 28 | 10 | 0 | 0 | 10 | 0 | 0 | 0 |
| ACRYLIC RESIN (4) | 52 | 28 | 10 | 0 | 0 | 0 | 10 | 0 | 0 |
| ACRYLIC RESIN (5) | 52 | 28 | 10 | 10 | 0 | 0 | 0 | 0 | 0 |
| ACRYLIC RESIN (6) | 53 | 28 | 10 | 0 | 0 | 0 | 0 | 9 | 0 |
| ACRYLIC RESIN (7) | 53 | 28 | 10 | 0 | 0 | 0 | 0 | 0 | 9 |

### <Preparation of Crystalline Polyester Resin Particle Dispersion Liquid (1)>

### (Synthesis of Crystalline Polyester (1))

Into a reactor equipped with a stirrer, a thermometer, a cooling tube, and a nitrogen gas-introducing tube, 281 parts by mass of dodecanedioic acid and 283 parts by mass of 1,6-hexanediol were charged. The atmosphere in the reaction vessel was replaced with dry nitrogen gas, then, 0.1 parts by mass of Ti (OBu)_{4/} was added, and the mixture was stirred and reacted under a nitrogen gas stream at about 180° C. for 8 hours. Further, 0.2 parts by mass of Ti (OBu)_{4/} was added, the temperature was raised to about 220° C., and the mixture was stirred and reacted for 6 hours. Then, the pressure in the reactor was reduced to 1333 2 Pa, and the mixture was reacted under reduced pressure to obtain crystal polyester 1. The crystalline polyester 1 had a number average molecular weight (Mn) of 5500, a weight average molecular weight (Mw) of 18000, and a melting point (Tc) of 67° C.

### (Preparation of Polyester Dispersion Liquid (1))

The crystalline polyester 1 (30 parts by mass) was melted and transferred in a molten state to an emulsifying disperser “CAVITRON CD1010” (manufactured by Eurotec Co., Ltd) at a transfer rate of 100 parts by mass per minute.

On the other hand, dilute ammonia water having a concentration of 0.37% by mass was prepared by diluting 70 parts by mass of reagent ammonia water with ion exchanged water.

Then, simultaneously with the transfer of the crystalline polyester 1 in a molten state, the diluted ammonium water was transferred to the emulsifying disperser “CAVITRON CD1010” at a transfer rate of 0.1 L per minute while being heated to 100° C. with a heat exchanger in an aqueous-solvent tank.

Next, the emulsification disperser “CAVITRON CD1010” was operated at a rotor rotation speed of 60 Hz and a pressure of 5 kg/cm². Thus, a crystalline polyester resin particle dispersion liquid (1) of a crystalline polyester 1 having a solid content of 30 parts by mass was prepared. At this time, the volume-based median size of particles included in the crystalline polyester resin particle-dispersion liquid (1) was 200 nm.

### <Preparation of Release Agent Particle—Dispersion Liquid (W1)>

Paraffinic wax (HNP0190 manufactured by Nippon Seiro Co., Ltd., melting temperature 85° C.) 270 parts by mass
anionic surfactant (Neogen RK manufactured by Dai-ichi Kogyo Seiyaku Co., Ltd) 13.5 parts by mass (active ingredient 60%, 3% relative to release agent)
Ion exchanged water 21.6 parts by mass

The materials described above were mixed, and the release agent was dissolved at an internal liquid temperature of 120° C. with a pressure ejection type homogenizer (Gaulin homogenizer manufactured by Gaulin, Inc).

Thereafter, the mixture was dispersed with a dispersion-pressure 5 MPa for 120 minutes and subsequently with a 40 MPa for 360 minutes, and cooled to obtain a dispersion liquid. Ion exchanged water was added to adjust the solid content to 20%, and this was defined as a release agent dispersion liquid (W1). The volume-average particle diameter of the particles in the release agent dispersion liquid (W1) was 215 nm.

### <Preparation of Cyan Pigment Dispersion Liquid 1>

In 1600 parts by mass of ion-exchanged water, 90 parts by mass of sodium lauryl sulfate was dissolved with stirring. While this solution was stirred, 420 parts by mass of copper phthalocyanine (C.I. Pigment Blue 15:3) was gradually added. Next, the mixture was subjected to dispersion treatment using a stirring apparatus CLEARMIX (manufactured by M Technique Co., Ltd), thereby preparing a dispersion liquid of colorant particles. The volume-based median size of the colorant particles in the cyan pigment-dispersion liquid 1 was measured, and it was 150 nm.

### <Production of Toner 1>

A reaction vessel equipped with a stirrer, a temperature sensor, and a cooling tube was prepared.

The following materials were charged into the reaction vessel.
acrylic binder resin particle dispersion liquid (1) 250 parts by mass (in terms of solid content)
Release agent particle dispersed liquid (W1) 30 parts by mass
dodecyl diphenyl ether disulfonic acid sodium salt 1% by mass in resin ratio (in terms of solid content)
Ion-exchanged water 2000 parts by mass

At room temperature (25° C.), a 5 mol/L aqueous sodium hydroxide solution was added to adjust the pH to 10. Furthermore, 30 parts by mass (in terms of solid content) of the cyan pigment dispersion liquid 1 and 30 parts by mass of the crystalline polyester resin particle dispersion liquid (1) were added. Next, a solution in which 60 parts by mass of magnesium chloride was dissolved in 60 parts by mass of ion-exchanged water was added under stirring at 30° C. over 10 minutes.

After being left to stand for 3 minutes, the temperature was increased to 80° C. over 60 minute, and after the liquid temperature reached 80° C., the stirring speed was adjusted so that the growth rate of the particle diameter was 0.01 μm/min. The particles were grown until the volume-based median diameter measured by Coulter Multisizer 3 (manufactured by Beckman Coulter, Inc) reached 6.8 μm.

An aqueous solution prepared by dissolving 190 parts by mass of sodium chloride in 760 parts by mass of ion-exchanged water was added to stop the growth of the particle diameter.

Furthermore, fusion of the particles was allowed to proceed by heating and stirring in a state of 80° C. Using an apparatus for measuring the average circularity of toner “FPIA-3000” (manufactured by Sysmex Corporation), the toner was cooled to 30° C. at a cooling rate of 2.5° C./min when the average circularity reached 0.970.

Next, solid-liquid separation was performed, and the dehydrated toner cake was washed by repeating three times the operation of re-dispersing in ion exchanged water and solid-liquid separation, and then dried at 40° C. for 24 hours to obtain toner particles.

The following particles were added to 100 parts by mass of the obtained toner particles, and mixed at 32° C. for 20 minutes with a Henschel mixer (manufactured by Mitsui Miike Machinery Co., Ltd) at a rotor blade circumferential speed of 35 m/sec.

hydrophobic silica particles (number-average primary particle diameter: 12 nm, degree of hydrophobicity:
68) 10 parts by mass
Alumina particles (number-average primary particle size: =12 nm) 0.44 parts by mass

After the mixing, coarse particles were removed using a sieve with an opening of 45 μm to obtain toner 1 using the biomass-derived material of Example 1 (¹⁴C). Note that the volume-based median diameter of the toner 1 was 6.6 μm.

### <Production of Toner 2 to Toner 9>

Toner 2 to toner 9 were produced while changing, for example, the type and amount of the binder resin used in the production of the toner 1, as described in the following Table III.

### Table 3

TABLE III

| | RESIN PARTICLE | | TONER PARTICLE COMPOSITION | | | | TONER PARTICLE | | | | |
|---|---|---|---|---|---|---|---|---|---|---|---|
| | DISPERSION | | (CHARGE AMOUNT) | | | | COMPOSITION(RATIO) | | | | |
| | LIQUID | | | CRYS- | RE- | | BIN- | CRYS- | RE- | | |
| | | WEIGHT | BINDER | TALLINE | LEASE | PIG- | DER | TALLINE | LEASE | PIG- | |
| | | AVER- | RESIN | POLY- | AGENT | MENT | RESIN | POLY- | AGENT | MENT | |
| | | AGE | CON- | ESTER | CON- | CON- | CON- | ESTER | CON- | CON- | |
| | | MOLE- | TENT | CONTENT | TENT | TENT | TENT | CON- | TENT | TENT | |
| | TYPE OF | CULAR | [PARTS | [PARTS | [PARTS | [PARTS | [% | TENT | [% | [% | |
| TONER | BINDER | WEIGHT | BY | BY | BY | BY | BY | [% BY | BY | BY | |
| No. | RESIN | Mw | MASS] | MASS] | MASS] | MASS] | MASS] | MASS] | MASS] | MASS] | NOTE |
| 1 | ACRYLIC | 30,000 | 250 | 30 | 30 | 30 | 74 | 9 | 9 | 9 | EXAMPLE 1 |
| | RESIN (1) | | | | | | | | | | |
| 2 | ACRYLIC | 35,000 | 250 | 30 | 30 | 30 | 74 | 9 | 9 | 9 | EXAMPLE 2 |
| | RESIN (2) | | | | | | | | | | |
| 3 | ACRYLIC | 25,000 | 250 | 30 | 30 | 30 | 74 | 9 | 9 | 9 | EXAMPLE 3 |
| | RESIN (3) | | | | | | | | | | |
| 4 | ACRYLIC | 30,000 | 250 | 30 | 30 | 30 | 74 | 9 | 9 | 9 | EXAMPLE 4 |
| | RESIN (4) | | | | | | | | | | |
| 5 | ACRYLIC | 30,000 | 200 | 60 | 30 | 30 | 63 | 19 | 9 | 9 | EXAMPLE 5 |
| | RESIN (1) | | | | | | | | | | |
| 6 | ACRYLIC | 30,000 | 250 | 0 | 30 | 30 | 81 | 0 | 10 | 10 | EXAMPLE 6 |
| | RESIN (1) | | | | | | | | | | |
| 7 | ACRYLIC | 110,000 | 250 | 30 | 30 | 30 | 74 | 9 | 9 | 9 | EXAMPLE 7 |
| | RESIN (5) | | | | | | | | | | |
| 8 | ACRYLIC | 30,000 | 250 | 30 | 30 | 30 | 74 | 9 | 9 | 10 | COM- |
| | RESIN (6) | | | | | | | | | | PARATIVE |
| | | | | | | | | | | | EXAMPLE 1 |
| 9 | ACRYLIC | 31,000 | 250 | 30 | 30 | 30 | 74 | 9 | 9 | 8 | COM- |
| | RESIN (7) | | | | | | | | | | PARATIVE |
| | | | | | | | | | | | EXAMPLE 2 |

The biomass degree of each acrylic resin is as illustrated in the following Table IV.

As described above, the biomass degree in the acrylic resin was calculated based on the total number of carbon atoms of the monomers (the number of carbon atoms of the biomass-derived monomer+the number of carbon atoms of the monomer other than the biomass-derived monomer), the number of moles of the monomers, the number of carbon atoms derived from the biomass, and the like.

Furthermore, the biomass degree in the toner particles was calculated on the basis of the biomass degree in the acrylic resin. Furthermore, the radiocarbon isotope concentration was calculated from the biomass degree in the toner particles and is presented in the following Table V.

### Table 4

TABLE IV

| | | | | | NUMBER OF | |
|---|---|---|---|---|---|---|
| | | | NUMBER OF | | MOLES × | |
| | | | MOLES × | | NUMBER OF | BIOMASS |
| | | NUMBER | NUMBER OF | BIO- | BIOMASS- | DEGREE |
| | | OF | CARBON | MASS- | DERIVED | IN |
| | | CARBON | ATOMS OF | DERIVED | CARBON | ACRYLIC |
| | | ATOMS OF | MONOMER | CARBON | ATOMS | RESIN |
| | | MONOMER | (A1) | ATOMS | (B1) | [%] (Y1) |
| ACRYLIC | St | 8 | 1.198 [symbol] | 0 | 0.0000 | 39. [symbol] |
| RESIN (1) | BA | 7 | 0.458 [symbol] | 7 | 0.4588 | |
| | IBXMA | 14 | 0.18 [symbol] 9 | 14 | 0.1889 | |
| | MAA | 4 | 0.1394 | 4 | 0.1394 | |
| | TOTAL | — | A2 = 1.9853 | — | (B2) = 0.7 [symbol] 71 | |
| ACRYLIC | St | 8 | 1.1983 | 0 | 0.0000 | 39.2 |
| RESIN (2) | BA | 7 | 0.4588 | 7 | 0.4588 | |
| | CYCLOHEXYL | 9 | 0.1751 | 9 | 0.1751 | |
| | ACRYLATE | | | | | |
| | MAA | 4 | 0.1 [symbol] 94 | 4 | 0.1394 | |
| | TOTAL | — | (A2) = 1.971 [symbol] | — | (B2) = 0.7733 | |
| ACRYLIC | St | 8 | 1.1 [symbol] 83 | 0 | 0.0000 | 39.3 |
| RESIN (3) | BA | 7 | 0.45 [symbol] 8 | 7 | 0.4588 | |
| | CYCLOHEXYL | 10 | 0.1783 | 10 | 01783 | |
| | METHACRYLATE | | | | | |
| | MAA | 4 | 0.1394 | 4 | 0.1394 | |
| | TOTAL | — | (A2) = 1.9747 | — | (B2) = 0.77645 | |
| ACRYLIC | St | 8 | 1.19 [symbol] 3 | 0 | 0.0000 | 40.9 |
| RESIN (4) | BA | 7 | 0.458 [symbol] | 7 | 0.4588 | |
| | IBXA | 13 | 0.2318 | 13 | 0.2318 | |
| | MAA | 4 | 0.13 [symbol] 4 | 4 | 0.13 [symbol] 4 | |
| | TOTAL | — | (A2) = 2.0282 | — | (B2) = 0.8300 | |
| ACRYLIC | St | 8 | 1.1983 | 0 | 0.0000 | 39.6 |
| RESIN (5) | BA | 7 | 0.45 [symbol] 8 | 7 | 0.4588 | |
| | IBXMA | 14 | 0.1 [symbol] 89 | 14 | 0.1889 | |
| | MAA | 4 | 0.1394 | 4 | 0.13 [symbol] 4 | |
| | TOTAL | — | (A2) = 1.9853 | — | (B2) = 0.7 [symbol] 71 | |
| ACRYLIC | St | 8 | 1.1983 | 0 | 0.0000 | 39.3 |
| RESIN (6) | BA | 7 | 0.458 [symbol] | 7 | 0458 [symbol] | |
| | OCTYL | 11 | 0.1791 | 11 | 0.1791 | |
| | ACRYLATE | | | | | |
| | MAA | 4 | 0.1394 | 4 | 0.1394 | |
| | TOTAL | — | (A2) = 1.975 [symbol] | — | (B2) = 0.7772 | |
| ACRYLIC | St | 8 | 1.198 [symbol] | 0 | 0.0000 | 39.4 |
| RESIN (7) | BA | 7 | 0.4588 | 7 | 0.4588 | |
| | OCTYL | 12 | 0.1815 | 12 | 0.1815 | |
| | METHACRYLATE | | | | | |
| | MAA | 4 | 0.1394 | 4 | 0.13 [symbol] 4 | |
| | TOTAL | — | (A2) = 1.9780 | — | (B2) = 0.77 [symbol] 7 | |

[symbol]

indicates data missing or illegible when filed

### Table 5

TABLE V

| | BIOMASS DEGREE | BIOMASS DEGREE | CONCENTRATION OF RADIOCARBON |
|---|---|---|---|
| | IN ACRYLIC RESIN | IN TONER PARTICLE | ISOTOPE IN TONER PARTICLE |
| | [%] | [%] | [pMC] |
| TONER | (Y1) | (Y2) | (X) |
| 1 | 39.6 | 29.1 | 31.3 |
| 2 | 39.2 | 28.8 | 31.0 |
| 3 | 39.3 | 28.9 | 31.1 |
| 4 | 40.9 | 30.1 | 32.3 |
| 5 | 39.6 | 24.8 | 26.6 |
| 6 | 39.6 | 31.9 | 34.3 |
| 7 | 39.6 | 29.1 | 31.3 |
| 8 | 39.3 | 28.9 | 31.1 |
| 9 | 39.4 | 29.0 | 31.1 |

### <Preparation of Developer>

Each of the toners obtained above was added to and mixed with a carrier coated with a silicone resin (ferrite carrier having a volume-based median diameter of 60 μm) so that the toner content (toner concentration) in the two component developer was 6% by mass. Thus, developers 1 to 9 were produced.

### Evaluation Method

As the evaluation method, the following two items of “fixing property test” and “heat-resistant storage property test” were performed.

### <Fixing Property Test>

As an image forming apparatus, a commercially available full-color multifunction peripheral “AccurioPress C3080 (manufactured by Konica Minolta, Inc)” modified so that surface temperatures of an upper fixing belt and a lower fixing roller can be changed was used, and the two component developers of the respective colors were sequentially loaded.

A test in which a solid image having a toner adhesion amount of 11.3 g/m² was output on A4 (grammage 90 g/m²) plain paper at a fixing temperature of 100° C. to 200° C. was repeatedly performed while changing the fixing temperature in increments of 5° C.

The lowest fixing temperature at which no image contamination due to fixing offset was visually observed was defined as the lowest fixing temperature, and the low-temperature fixing property was evaluated according to the following evaluation criteria. In the following criteria, A to C were regarded as passing.

### (Criteria)

A: Lowest fixing temperature of less than 135° C. (low-temperature fixing property of toner is extremely good)
B: Minimum fixing temperature is 135° C. or more and less than 145° C. (low-temperature fixing property of toner is good):
C: Lowest fixing temperature of 145° C. or more and less than 155° C. (low-temperature fixing property of toner is satisfactory)
D: minimum fixing temperature of 155° C. or higher (the toner has poor low-temperature fixing property and cannot be used)

### <Heat-Resistant Storage Property Test>

The toner 0.5 g was placed in a 10 ml glass bottle with a 21 mm inside diameter, the lid was closed, and the glass bottle was shaken with Tap Denser KYT-2000 (manufactured by Seishin Enterprise Co., Ltd) at room temperature for 600 times. Thereafter, the container was left to stand under an environment of 55° C. and 35% RH for 2 hours with the lid removed.

Next, the toner was placed on a 48-mesh sieve (opening: 350 μm) while taking care not to crush aggregates of the toner, set in a powder tester (manufactured by Hosokawa Micron Corporation), and fixed with a pressing bar and a knob nut. Thereafter, the vibration intensity is adjusted to the vibration intensity of the feed amount 1 mm, and the 1

After the vibration was applied for 0 seconds, the ratio (% by mass) of the amount of the toner remaining on the sieve was measured.

The toner aggregation rate is a value calculated by the following formula.

$$( toner aggregation rate ( \% ) ) = ( weight of remaining toner on sieve ( g ) ) / 0.5 ( g ) \times 100$$

The same measurement was performed at temperatures of 57.5° C. and 60° C., and plotted with the temperature on the X axis and the toner aggregation rate on the Y axis. Among the temperatures of 55° C., 57.5° C., and 60° C., an approximate straight line was drawn between two temperatures sandwiching a region in which the toner aggregation rate was 50%, the temperature at which the toner aggregation rate was 50% was calculated from interpolation, and evaluation was performed based on the following evaluation criteria. In the following criteria, A to C were regarded as passing.

### (Criteria)

A: 59° C. or higher
B: 58° C. or more and less than 59
C: 57° C. or more and less than 58° C.
D: less than 57° C.

### Table 6

TABLE VI

| | EVALUATION | | |
|---|---|---|---|
| | HEAT-RESISTANT | FIXING | |
| TONER No. | STORAGE PROPERTY | PROPERTY | NOTE |
| 1 | A | A | EXAMPLE 1 |
| 2 | B | B | EXAMPLE 2 |
| 3 | B | B | EXAMPLE 3 |
| 4 | B | B | EXAMPLE 4 |
| 5 | B | A | EXAMPLE 5 |
| 6 | B | B | EXAMPLE 6 |
| 7 | A | C | EXAMPLE 7 |
| 8 | D | B | COMPARATIVE |
| | | | EXAMPLE 1 |
| 9 | D | B | COMPARATIVE |
| | | | EXAMPLE 2 |

As illustrated in the results above, the toner according to the present embodiment is found to be excellent in fixing property and heat-resistant storage property as compared with the toners of the comparative examples even when the biomass-derived material is used in a high ratio.

By increasing the ratio of the biomass-derived material by the above-described means of the present embodiment, it is possible to provide an electrostatic charge image developing toner and an image forming method that are environmentally friendly and can achieve both fixing property and heat-resistant storage property.

The expression mechanism or action mechanism of the effect is not clear, but it is presumed as follows.

Since the electrostatic charge image developing toner of the present embodiment has a concentration of the radiocarbon isotopes ¹⁴C of 21.5 pMC or more, it has a high ratio of coping with the environment.

Here, 21.5 pMC is converted into a biomass degree of 20%. The biomass degree of 20% is a number which is often defined as the minimum biomass degree required for obtaining various biomass-related authentications.

However, when the biomass degree is high and the ratio derived from the biomass raw material increases, fixing property and heat-resistant storage property cannot be sufficiently ensured.

Therefore, it has been found that by using an alicyclic alkyl-based monomer among the biomass-derived materials, the biomass-derived material can be used at a higher ratio while maintaining the fixing property and the heat-resistant storage property.

By using an alicyclic alkyl-based monomer, the structure of the side chain of the polymer becomes bulky and the main chain becomes rigid. Due to the partial increase of the rigid structure, the local intermolecular interaction (van der Waals force) between the polymer chains increases, and as a result, the heat-resistant storage property improves.

In addition, as a factor for making the main chain rigid, the main chain can also be made rigid by changing the structure of the R₁ in the general formula (1) from a hydrogen atom to a methyl radical. That is, methacrylate is more preferable than acrylate.

Furthermore, from the viewpoint of ensuring fixing property and heat resistance, the concentration of the radiocarbon isotopes ¹⁴C is preferably 85.6 pMC (80% when converted into the biomass degree) or less.

Although embodiments of the present invention have been described and illustrated in detail, the disclosed embodiments are made for purposes of illustration and example only and not limitation. The scope of the present invention should be interpreted by terms of the appended claims.

The entire disclosure of Japanese Patent Application No. 2023-181525 filed on Oct. 23, 2023 is incorporated herein by reference in its entirety.

What is claimed is:

1. An electrostatic charge image developing toner comprising a toner base particle containing a binder resin and a colorant, wherein
the electrostatic charge image developing toner contains, as the binder resin, a polymer having at least a structural unit represented by a general formula (1), and
a concentration of radiocarbon isotope ¹⁴C is 21.5 pMC or more, 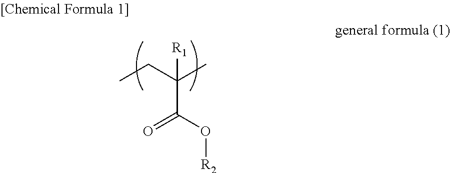
in the general formula (1), R₁ represents a hydrogen atom or a methyl group, and R₂ represents an alicyclic hydrocarbon group having 6 to 12 carbon atoms.

2. The electrostatic charge image developing toner according to claim 1, wherein the polymer having the structural unit represented by the general formula (1) has a weight average molecular weight in a range of 5000 to 100000, as measured by gel permeation chromatography.

3. The electrostatic charge image developing toner according to claim 1, wherein the concentration of the radiocarbon isotope ¹⁴C is 32.3 pMC or more.

4. The electrostatic charge image developing toner according to claim 1, wherein R₂ in the general formula (1) is an isobornyl group.

5. The electrostatic charge image developing toner according to claim 1, wherein R₁ in the general formula (1) is a methyl group.

6. The electrostatic charge image developing toner according to claim 1, wherein the toner base particle contains a crystalline polyester in a range of 5 to 20% by mass.

7. An image forming method comprising using an electrostatic charge image developing toner, wherein
the electrostatic charge image developing toner is the electrostatic charge image developing toner according to claim 1.
